(19) United States
(12) Patent Application Publication
(10) Pub. No.: US 2008/0231506 A1
(43) Pub. Date: Sep. 25, 2008

(54) SYSTEM, METHOD AND COMPUTER READABLE MEDIA FOR IDENTIFYING THE TRACK ASSIGNMENT OF A LOCOMOTIVE

(76) Inventors: Craig Alan Stull, Kansas City, MO (US); Tom Otsubo, Oak Grove, MO (US); Jeffrey Baker, Overland Park, KS (US)

Correspondence Address: BEUSSE WOLTER SANKS MORA & MAIRE, P.A., 390 NORTH ORANGE AVENUE, SUITE 2500, ORLANDO, FL, 32801, US

(21) Appl. No.: 12/021,654

(22) Filed: Jan. 29, 2008

Related U.S. Application Data
(60) Provisional application No. 60/895,610, filed on Mar. 19, 2007.

(51) Int. Cl. G01S 5/00

(52) U.S. Cl. 342/357.07

(57) ABSTRACT

A system is provided for identifying the track assignment of a locomotive traveling along a track. The system includes at least one onboard receiver on the locomotive for wirelessly communicating with a plurality of satellites to provide a respective initial location of at least one onboard antenna on the locomotive. Additionally, the system includes at least one wayside receiver wirelessly coupled to the at least one onboard receiver. The at least one wayside receiver is positioned adjacent to the track to wirelessly communicate with the plurality of satellites to provide a respective corrected location of the respective initial location of the at least one onboard antenna to the at least one onboard receiver. A method and computer readable media are also provided for identifying the track assignment of a locomotive traveling along a track.

### CROSS-REFERENCE TO RELATED APPLICATIONS

This application is based on and claims priority to U.S. Provisional Application No. 60/895,610 filed Mar. 19, 2007.

### BACKGROUND OF THE INVENTION

Locomotives are routinely assigned to a particular track, usually in the form of a track number, typically for purposes of movement planning, such as scheduling a route. Additionally, several train control systems enforce control signals for controlling the locomotive at distinct areas along particular tracks. Thus, if a train control system is not aware of the locomotive's properly assigned track number, and whether this number coincides with the track that the locomotive is currently on, the train control system has little certainty it is enforcing the correct control signals for that locomotive.

Some methods are currently available to assist in identifying a locomotive's current track number. However, these methods have significant shortcomings, particularly in multiple-track regions, where locomotives typically initiate motion and require identification of their track number. For example, wayside equipment such as axle counters and track circuits require significant maintenance which is undesirable in several areas, including multiple-track regions. Additionally, low cost GPS technology has been used in conjunction with track switch direction to support identification of a locomotive track number. However, such technology only provides meaningful identification of the locomotive track number in single track areas or requires the train to move before being able to determine the correct track assignment.

Thus, many current train control systems are not equipped to identify the locomotive track number in a multiple track area, and thus the locomotive operator must manually determine the track number in the multiple track area by radio, visually, or by pure speculation. Accordingly, it would be advantageous to provide a system capable of identifying the locomotive track number in a multiple track area, thereby permitting accurate enforcement of signals for train control systems from the time that the locomotive moves from the multiple track area and outwardly along its route.

### BRIEF DESCRIPTION OF THE INVENTION

In one embodiment of the present invention, a system is provided for identifying the track assignment of a locomotive traveling along a track. The system includes at least one onboard receiver on the locomotive for wirelessly communicating with a plurality of satellites to provide a respective initial location of at least one onboard antenna on the locomotive. Additionally, the system includes at least one wayside receiver wirelessly coupled to the at least one onboard receiver. The at least one wayside receiver is positioned adjacent to the track to wirelessly communicate with the plurality of satellites to provide a respective corrected location of the respective initial location of the at least one onboard antenna to the at least one onboard receiver.

In another embodiment of the present invention, a method is provided for identifying the track assignment of a locomotive traveling along a track. The method includes wirelessly communicating at least one onboard receiver on the locomotive with a plurality of satellites, followed by determining a respective initial location of at least one onboard antenna on the locomotive. The method further includes wirelessly coupling at least one wayside receiver to the at least one onboard receiver, where the at least one wayside receiver is positioned adjacent to the track. The method further includes wirelessly communicating the at least one wayside receiver with the plurality of satellites to provide a respective corrected location of the respective initial location of the at least one onboard antenna to the at least one onboard receiver.

In another embodiment of the present invention, computer readable media is provided for identifying the track assignment of a locomotive traveling along a track. At least one onboard receiver on the locomotive is configured to wirelessly communicate with a plurality of satellites such that a respective initial location of at least one onboard antenna on the locomotive is determined. Additionally, at least one wayside receiver positioned adjacent to the track is wirelessly coupled to the at least one onboard receiver. The at least one wayside receiver is configured to wirelessly communicate with the plurality of satellites to provide a respective corrected location of the respective initial location of the at least one onboard antenna to the at least one onboard receiver. The computer readable media includes a computer program code for determining the respective corrected location of the respective initial location of the at least one onboard antenna.

### BRIEF DESCRIPTION OF THE DRAWINGS

A more particular description of the invention briefly described above will be rendered by reference to specific embodiments thereof that are illustrated in the appended drawings. Understanding that these drawings depict only typical embodiments of the invention and are not therefore to be considered to be limiting of its scope, the embodiments of the invention will be described and explained with additional specificity and detail through the use of the accompanying drawings in which:

FIG. 1 is a schematic diagram of one embodiment of a system for identifying the track assignment of a locomotive;

FIG. 2 is a partial schematic diagram of one embodiment of a system for identifying the track assignment of a locomotive; and

FIG. 3 is a flow chart illustrating an exemplary embodiment of a method for identifying the track assignment of a locomotive.

### DETAILED DESCRIPTION OF THE INVENTION

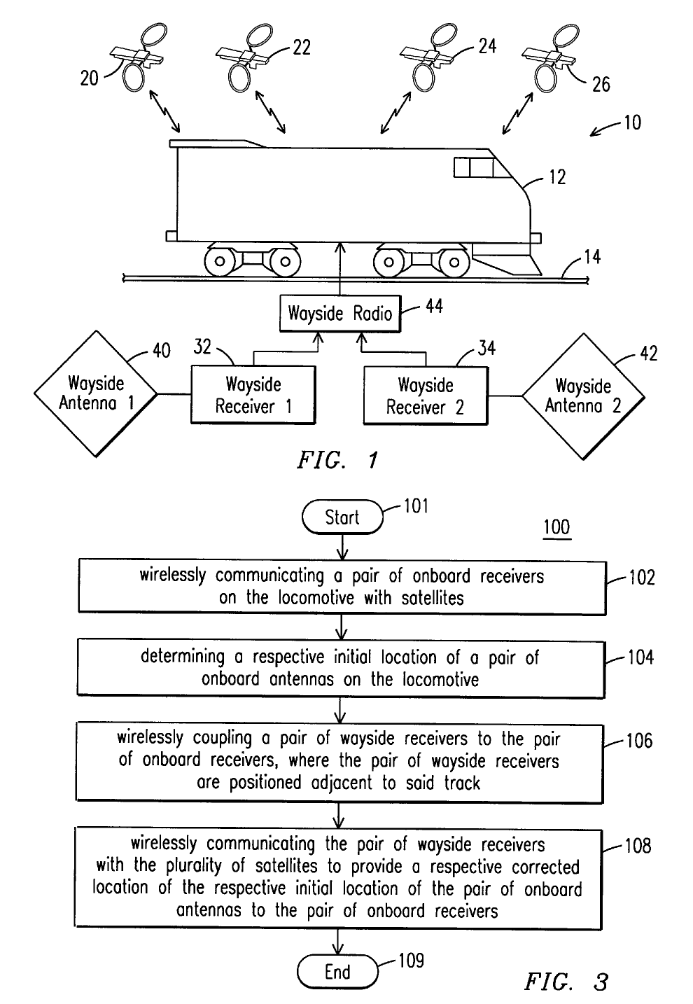

FIG. 1 illustrates a system 10 to identify the track assignment of a locomotive 12 traveling along a track 14, particularly in a multiple-track region. The track 14 may be one track among a plurality of tracks in such a multiple-track region, for example. In an exemplary embodiment of the invention, the track assignment used is a track identification parameter, such a track number, but other track assignments may be utilized and are within the scope of the subject invention.

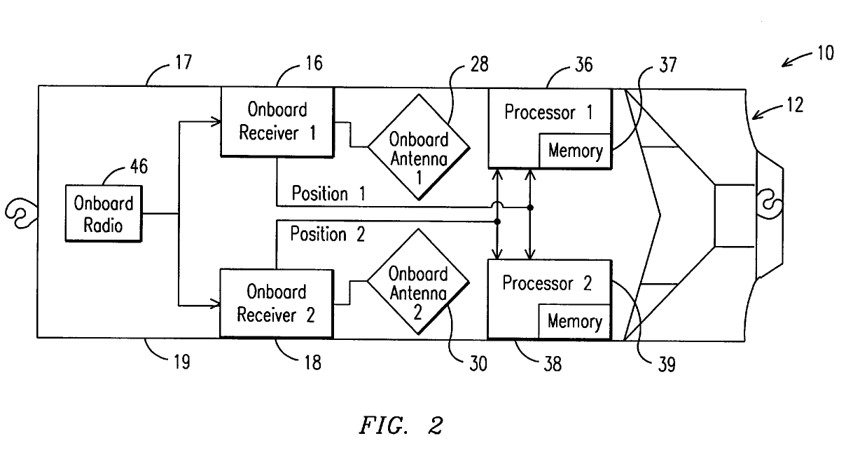

As illustrated in the exemplary embodiment of FIG. 2, the system 10 includes a pair of onboard receivers 16,18, such as GPS rover receivers, for example, positioned onboard the locomotive 12 such that they are approximately symmetric with respect to the center-line of the track 14. Although FIG. 2 illustrates the onboard receivers 16,18, positioned adjacent to opposing sides 17,19 of the locomotive 12, in an exemplary embodiment, the onboard receivers may be positioned adjacent to opposing ends of the locomotive, for example. In such an exemplary embodiment in which the onboard receivers are positioned at opposing ends of the locomotive, this arrangement may have various advantages, such as mitigating multi-path effects, for example.

The onboard receivers 16,18 wirelessly communicate with four GPS satellites 20,22,24,26 to provide a respective initial location of a respective onboard antenna 28,30. As is appreciated by one of skill in the art, the onboard receivers 16,18 determine the initial location of each respective onboard antenna 28,30, such a GPS rover antenna, for example, by determining the pseudorange from the onboard antennas 28,30 to each respective GPS satellite 20,22,24,26, and utilize these values to approximate the latitude, longitude, height and time for each onboard antenna 28,30. In an exemplary embodiment of the system 10, the onboard receiver, and wayside receiver (discussed below) either both exclusively utilize an L1 GPS satellite frequency or respectively utilize the L1 and L2 GPS satellite frequencies to determine the onboard antenna position, so to reduce or eliminate error sources attributed to ionospheric effects, ephemeris errors, GPS satellite clock errors, and tropospheric effects, for example. However, the system is not limited to the onboard receiver and wayside receiver (discussed below) utilizing the L1 and L2 GPS satellite frequencies and may utilize any future available satellite GPS frequencies, or other GPS augmentation systems such as WAAS, as appreciated by one of skill in the art. Although the pair of onboard receivers 16,18 and their respective corresponding onboard antennas 28,30 are positioned as shown in FIG. 2, any number of onboard receivers and corresponding onboard antennas may be utilized and may be positioned at any location along the locomotive. In an exemplary embodiment of the system 10, when utilizing different GPS satellite frequencies for the onboard receivers 16,18 and wayside receivers (discussed below), an accuracy in determining the position of the track 14 (and thus the identity of the track) with sufficient accuracy to discriminate between multiple tracks in multiple track areas where tracks are spaced apart by approximately fifteen feet is achieved, for example. In one exemplary embodiment, the system is capable of determining the location of adjacent tracks which are separated by more than 6 feet, for example, such as in a multiple track area.

Additionally, as illustrated in FIG. 1, the system 10 includes a pair of wayside receivers 32,34, such as a pair of GPS reference receivers, for example, coupled to a respective pair of wayside antennas 40,42. Prior to the wayside receivers wirelessly communicating with the GPS satellites 20,22,24,26, the locations of each wayside antenna 40,42 are surveyed, including their respective latitude, longitude and height. However, the actual location of the wayside antennas 40,42 may be determined by any acceptable method appreciated by one of skill in the art, and subsequently inputted into the wayside receivers 32,34 (see below). The surveyed location of each wayside antenna 40,42 is then input into a respective wayside receiver 32,34. Upon entering the surveyed location of each wayside antenna, each wayside receiver 32,34 wirelessly communicates with each GPS satellite 20,22,24,26 to determine a measured location for each respective wayside antenna 40,42 based on a set of pseudoranges from the wayside antennas 40,42 to the GPS satellites 20,22,24,26. Each wayside receiver then evaluates the measured location for each antenna and the surveyed location to determine a pseudorange correction from the wayside antenna 40,42 to the GPS satellites 20,22,24,26, which is in-turn used to determine an error in the measured position. The measured location of the wayside antenna 40,42 may be enhanced by incorporating the pseudorange corrections into the pseudoranges from the wayside antenna 40,42 to the GPS satellites 20,22,24,26. In an exemplary embodiment of the system 10, the error in the measured position for each wayside antenna is used to determine a pseudorange correction for each GPS satellite 20,22,24,26. Although the pair of wayside receivers 32,34 and their respective corresponding wayside antennas 40,42 are positioned as shown in FIG. 1, a respective wayside receiver and wayside antenna are typically incrementally spaced along the locomotive track, and more than one pair of respective wayside receivers and wayside antennas may be positioned at each incremental location. In one exemplary embodiment of the system, each pair of wayside receivers and wayside antennas may be incrementally spaced every 30 miles, for example. The wayside receivers 32,34 calculate a pseudorange correction to each GPS satellite 20,22,24,26 based on the measured error in the position of the wayside antennas 40,42 between the surveyed position and the GPS measured position. Thus, the pseudorange correction for each GPS satellite 20,22,24,26 is subsequently factored into the measured pseudorange to each GPS satellite, so to minimize the error of each GPS measurement. In the exemplary embodiment of FIGS. 1-2, the pair of wayside receivers 32,34 are collectively coupled to a wayside radio 44 adjacent to the track 14, and thereby collectively wirelessly communicate the pseudorange corrections of the respective GPS satellites 20,22,24,26 through the wayside radio to an onboard radio 46 positioned on the locomotive 12.

In an additional exemplary embodiment of the system 10, in place of the wayside receivers 32,34, the pseudorange corrections for each GPS satellite 20,22,24,26 to the onboard antennas 28,30 may be provided by one of a number of GPS satellite subscription services, as appreciated by one of skill in the art.

As illustrated in FIGS. 1-2, each respective wayside receiver 32,34 is wirelessly coupled (via. a wayside radio 44) to the onboard receivers 16,18. The pseudorange correction determined by each respective wayside receiver 32,34, discussed above, is subsequently incorporated into the pseudoranges between the onboard antennas 28,30 and the GPS satellites 20,22,24,26 to provide a corrected location to the respective initial location of each onboard antenna 28,30 determined by the respective onboard receiver 16,18. Each wayside receiver 32,34 is illustratively positioned adjacent to the track 14 to wirelessly communicate with the locomotive 12 when the locomotive passes within a proximate distance of the wayside receivers 32,34. The wayside receivers 32,34 provide respective pseudorange corrections for the GPS satellites 20,22,24,26 used to determine the location of each onboard antenna 28,30, to the respective onboard receiver 16,18 of each onboard antenna 28,30. As discussed earlier, each pseudorange correction is based on the corrected location of the wayside antennas 40,42. Upon receiving the respective pseudorange correction of each onboard antenna 28,30 location, each onboard receiver 16,18 determines the corrected location of each onboard antenna 28,30 based upon the initial location of the onboard antennas and the pseudorange corrections provided by the wayside receivers. In an exemplary embodiment of the system 10, the corrected location for each onboard antenna 28,30 includes 4 pseudorange corrections for each of the 4 respective GPS satellite ranges. In another exemplary embodiment of the system, the onboard receivers 16,18 sample the wayside receivers 32,34 at regular time intervals for corrected locations for the respective onboard antennas 28,30 as the locomotive is traveling along the track 14, such as every 1 second, for example.

As illustrated in FIG. 2, a pair of processors 36, 38 are coupled to each pair of onboard receivers 16,18 to receive each corrected location of each onboard antenna 28,30 from each respective onboard receiver 16,18. Upon each processor 36,38 receiving the corrected location of each onboard antenna 28,30, each processor averages the corrected locations of the onboard antennas, such as by passing the corrected locations through a Kalman filter, for example. Additionally, upon averaging the corrected locations of each onboard antenna 28,30, the system 10 provides a step where each processor 36,38 mutually compares its respective computed average to ensure the respective averages of the corrected locations of onboard antennas are equal, or within an acceptable range, for example. Additionally, each processor 36,38 may compare the respective corrected locations, to ensure that they fall within an acceptable geographic range, to determine that the system 10 is functioning correctly. By averaging the two onboard antenna locations, each processor maps the onboard antenna locations onto the track 14 location. In the event that one of an onboard receiver 16,18 or processor 36,38 in the system 10 fails, the other onboard receiver 16,18 and processor 36,38 of the pair still communicate to average the two onboard antenna locations. Although FIG. 2 illustrates a first embodiment of the system 10, including two processors 36,38, the system may include a second embodiment, including one processor, one onboard receiver and one onboard antenna on each locomotive, for example. In the second embodiment of the system, other devices such as an additional tachometer, for example may be utilized to provide a backup for location determination. In the first embodiment of the system 10, a tachometer may be additionally utilized during instances of non-GPS reception, such as entering a tunnel for example, when monitoring locomotive speed may be used to determine the locomotive position and thereby continuously monitor the track position. In addition to a tachometer, other navigational aids may be utilized during instances of non-GPS reception, such as an accelerometer and/or a gyro, for example.

In an exemplary embodiment of the system, upon mapping the corrected positions of each onboard antenna onto the track, the processors may use this to identify the locomotive track number by one of a number of ways. The processor(s) 36,38 may include a memory 37,39 in which the track identification numbers are stored for the range of latitude/longitude/height values, and the processor(s) 36,38 may determine the track identification number by looking up the average onboard antenna 28,30 latitude/longitude/height in the processor(s) memory 37,39, for example. In addition, the processor(s) 36,38 could send a track position signal to a central control station and receive a track identification signal confirming the correct identification of the track number.

Other devices or technology may be utilized to determine the location of the locomotive 12, and thus identify the track assignment of the locomotive 12, and are within the scope of the embodiments of the invention, including various wayside devices, such as axle counters and track circuits, cab signals which provide a track identification to the locomotive, balise or tag reader devices that provide track identification to the train, train driver input via a user interface in the locomotive, track number designation by the dispatcher using a scheme that requires the locomotive to occupy blocks and report its location to the dispatcher, radar ranging technology, laser ranging technology, other global positioning systems such as GloNass, Galileo, and associated GPS satellite based augmentations (WAAS, EGNOS, MSAS and other future augmentation systems).

FIG. 3 illustrates an exemplary embodiment of a method 100 for identifying the track assignment of a locomotive 12 traveling along a track 14. The method 100 begins at 101 by wirelessly communicating 102 the pair of onboard receivers 16,18 on the locomotive 12 with a plurality of GPS satellites 20,22,24,26. The method 100 further includes determining 104 a respective initial location of the pair of onboard antennas 28,30 on the locomotive 12. The method 100 further includes wirelessly coupling 106 the pair of wayside receivers 32,34 to the pair of onboard receivers 16,18, where the pair of wayside receivers 32,34 are positioned adjacent to the track 14. The method 100 further includes wirelessly communicating 108 the pair of wayside receivers 32,34 with the GPS satellites 20,22,24,26 to provide a respective corrected location of the respective initial location of the pair of onboard antennas 28,30 to the pair of onboard receivers 16,18, before ending at 109.

Based on the foregoing specification, the above-discussed embodiments of the invention may be implemented using computer programming or engineering techniques including computer software, firmware, hardware or any combination or subset thereof, wherein a technical effect is to identify the track assignment of a locomotive traveling along a track. Any such resulting program, having computer-readable code means, may be embodied or provided within one or more computer-readable media, thereby making a computer program product, i.e., an article of manufacture, according to the discussed embodiments of the invention. The computer readable media may be, for instance, a fixed (hard) drive, diskette, optical disk, magnetic tape, semiconductor memory such as read-only memory (ROM), etc., or any emitting/receiving medium such as the Internet or other communication network or link. The article of manufacture containing the computer code may be made and/or used by executing the code directly from one medium, by copying the code from one medium to another medium, or by transmitting the code over a network.

One skilled in the art of computer science will easily be able to combine the software created as described with appropriate general purpose or special purpose computer hardware, such as a microprocessor, to create a computer system or computer sub-system of the method embodiment of the invention. An apparatus for making, using or selling embodiments of the invention may be one or more processing systems including, but not limited to, a central processing unit (CPU), memory, storage devices, communication links and devices, servers, I/O devices, or any sub-components of one or more processing systems, including software, firmware, hardware or any combination or subset thereof, which embody those discussed embodiments the invention.

This written description uses examples to disclose embodiments of the invention, including the best mode, and also to enable any person skilled in the art to make and use the embodiments of the invention. The patentable scope of the embodiments of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

That which is claimed is:

1. A system for identifying a track assignment of a locomotive traveling along a track, comprising:
at least one onboard receiver on said locomotive for wirelessly communicating with a plurality of satellites to provide a respective initial location of at least one onboard antenna on said locomotive; and
at least one wayside receiver wirelessly coupled to said at least one onboard receiver; said at least one wayside receiver positioned adjacent to said track for wirelessly communicating with said plurality of satellites to provide a respective corrected location of said respective initial location of said at least one onboard antenna to said at least one onboard receiver.

2. The system of claim 1, wherein said track is one of a plurality of adjacent tracks in a multiple-track region, said locomotive being configured to travel along said track in said multiple-track region.

3. The system of claim 2, wherein each of said plurality of adjacent tracks in said multiple-track region is assigned a respective track identification parameter.

4. The system of claim 1, wherein said system includes a pair of onboard receivers and a respective pair of onboard antennas, said onboard receivers being symmetrically positioned on said locomotive with respect to a center-line along said track.

5. The system of claim 4, wherein said pair of onboard receivers are a pair of GPS rover receivers, said pair of onboard antennas are a pair of GPS rover antennas.

6. The system of claim 4, wherein said pair of onboard receivers are positioned adjacent to opposing sides of said locomotive.

7. The system of claim 4, wherein said pair of onboard receivers are positioned adjacent to opposing ends of said locomotive.

8. The system of claim 4, wherein said pair of onboard receivers are configured to wirelessly communicate with four satellites to determine a respective first set of pseudoranges from said respective onboard antenna to said four satellites, said pair of onboard receivers is configured to determine a respective measured location of said pair of onboard antennas based on said respective first set of pseudoranges.

9. The system of claim 8, wherein said system includes a pair of wayside receivers and a respective pair of wayside antennas, an actual location of said pair of wayside antennas is determined and inputted into said pair of wayside receivers.

10. The system of claim 9, wherein said pair of wayside receivers are a pair of GPS reference receivers, said pair of wayside antennas are a pair of GPS reference antennas.

11. The system of claim 9, wherein upon inputting said actual location of said pair of wayside antennas into said pair of wayside receivers, said pair of wayside receivers wirelessly communicate with said satellites to determine a respective second set of pseudoranges from said respective wayside antenna to said four satellites to determine a measured location of said respective wayside antenna.

12. The system of claim 11, wherein said pair of wayside receivers is configured to compare said measured location with said actual location to determine a set of pseudorange corrections from said respective wayside antenna to said four satellites, wherein an accuracy of said measured location is enhanced by incorporating said set of pseudorange corrections into said second set of pseudoranges.

13. The system of claim 12, wherein said pair of wayside receivers is configured to wirelessly communicate said set of pseudorange corrections to said pair of onboard receivers on said locomotive when said locomotive passes within a proximate distance of said pair of wayside receivers; said pair of onboard receivers are configured to incorporate said set of pseudorange corrections into said first set of pseudoranges to enhance an accuracy of determining said measured location of said pair of onboard antennas.

14. The system of claim 13, further comprising a pair of onboard processors on said locomotive coupled to said pair of onboard receivers, each onboard receiver is configured to transmit said respective measured location of said respective onboard antenna to said pair of onboard processors, each onboard processor is configured to compute a respective average measured location of said pair of onboard antennas, said onboard processors are configured to mutually compare the respective average measured locations of said pair of onboard antennas.

15. The system of claim 1, wherein said system includes one onboard receiver and one onboard antenna, said onboard receiver is configured to wirelessly communicate with four satellites to determine a respective first set of pseudoranges from said onboard antenna to said four satellites, said onboard receiver is configured to determine a measured location of said onboard antenna based on said first set of pseudoranges.

16. A method for identifying a track assignment of a locomotive traveling along a track, said method comprising:
wirelessly communicating at least one onboard receiver on said locomotive with a plurality of satellites;
determining a respective initial location of at least one onboard antenna on said locomotive;
wirelessly coupling at least one wayside receiver to said at least one onboard receiver; said at least one wayside receiver positioned adjacent to said track;
wirelessly communicating said at least one wayside receiver with said plurality of satellites to provide a respective corrected location of said respective initial location of said at least one onboard antenna to said at least one onboard receiver.

17. The method of claim 16, wherein said method further comprises wirelessly communicating a pair of onboard receivers with four satellites, and determining a respective initial location of a pair of onboard antennas on said locomotive.

18. The method of claim 17, further comprising:
determining a respective first set of pseudoranges from said respective onboard antenna to said four satellites, based on said wirelessly communicating said pair of onboard receivers with said four satellites; and
determining a measured location of said pair of onboard antennas based on said first set of pseudoranges.

19. The method of claim 18, further comprising:
determining an actual location of a pair of wayside antennas; and
inputting said actual location of said pair of wayside antennas into said pair of wayside receivers.

20. The method of claim 19, further comprising:
determining a respective second set of pseudoranges from said respective wayside antenna to said four satellites based on said wirelessly communicating a pair of wayside receivers with said four satellites; and
determining a measured location of said pair of wayside antennas based on said second set of pseudoranges.

21. The method of claim 20, further comprising:
comparing said measured location of said pair of wayside antennas with said actual location of said pair of wayside antennas to determine a set of pseudorange corrections from said respective wayside antenna to said four satellites; and
wirelessly communicating said set of pseudorange corrections to said pair of onboard receivers on said locomotive when said locomotive passes within a proximate distance of said pair of wayside receivers; and
incorporating said set of pseudorange corrections into said first set of pseudoranges to enhance an accuracy of determining said measured location of said pair of onboard antennas.

22. Computer readable media for identifying a track assignment of a locomotive traveling along a track, wherein at least one onboard receiver on said locomotive is configured to wirelessly communicate with a plurality of satellites such that a respective initial location of at least one onboard antenna on said locomotive is determined; at least one wayside receiver positioned adjacent to said track is wirelessly coupled to said at least one onboard receiver, said at least one wayside receiver is configured to wirelessly communicate with said plurality of satellites to provide a respective corrected location of said respective initial location of said at least one onboard antenna to said at least one onboard receiver, said computer readable media comprising:
a computer program code for determining said respective corrected location of said respective initial location of said at least one onboard antenna.
